(19) United States
(12) Patent Application Publication
(10) Pub. No.: US 2010/0072650 A1
(43) Pub. Date: Mar. 25, 2010

(54) METHOD AND DEVICE FOR OPERATING A DRAWING LINE OR DRAWING UNIT

(76) Inventors: Rolf Schroeder, Langen (DE); Michael Breidert, Erzhausen (DE)

Correspondence Address: Muncy, Geissler, Olds & Lowe, PLLC, P.O. BOX 1364, FAIRFAX, VA, 22038-1364, US

(21) Appl. No.: 12/625,032

(22) Filed: Nov. 24, 2009

Related U.S. Application Data
(63) Continuation of application No. PCT/DE2008/000663, filed on Apr. 15, 2008.

(30) Foreign Application Priority Data
May 24, 2007 (DE) 10 2007 024 350.4

(51) Int. Cl. B29C 47/92

(52) U.S. Cl. 264/40.7; 425/145

(57) ABSTRACT

A method and device for operating a drawing line or drawing unit for drawing cables from polymer threads using a plurality of driven drawing rollers. According to the invention, each drawing roller is controlled to a prescribed motion value. To this end, each drawing roller is associated with a separately controllable drive device.

This nonprovisional application is a continuation of International Application No. PCT/DE2008/000663, which was filed on Apr. 15, 2008, and which claims priority to German Patent Application No. 10 2007 024 350.4, which was filed in Germany on May 24, 2007, and which are both herein incorporated by reference.

### BACKGROUND OF THE INVENTION

1. Field of the Invention

The invention relates to a method and a device for operating a drawing line or drawing unit.

2. Description of the Background Art

DE 21 48 619 illustrates a device for drawing of tows having high polymer synthetic filaments in drawing units with intake units and drawing units where the tow mass is divided into several individual tows.

### SUMMARY OF THE INVENTION

It is an object of the present invention to provide a method and a device for driving a drawing unit in line.

In an embodiment, each drawing roller can be driven by a separate drive unit that can be controlled by an actuator to operate at a specified speed or with the torque required for driving the relevant drawing roller. Different speeds (rotational speeds) of two drawing units allow the tows or filaments passing round the drawing rollers to be drawn by a certain amount. The accumulated speed ratio from the first intake drawing roller to the last discharge drawing roller can range, for example, from 1:3 to 1:4. Since the individual drawing rollers or godets are not driven centrally by one drive unit, but each godet instead is driven individually, the drawing unit can be operated more precisely. It is also an advantage that the drives within one drawing unit are nearly identical and that the load can be distributed evenly. Slip can be considerably reduced by the individual drives.

In an embodiment, the required torque of the drive unit can be set or the drives of the individual godets can be operated through a control unit.

In another embodiment, the motors can be designed as asynchronous drives and the control unit can contain a frequency converter including a tacho-generator connectable to the motor. The frequency converter can be used to set the required rotational speed and thus also the torque of one godet each. The frequency converter allows the required optimum speed to be adjusted for each individual motor. For more complex control requirements, field-oriented converters can be used. These can include a speed controller based on a secondary current controller. The motor characteristics are saved or possibly even automatically determined and adapted in an electronic motor model stored in the converter. This offers the advantage that there has to be no separate speed measurement and feedback for controlling speed and torque. The only feedback used for control is the instantaneous current. Based on current level and phase relation to voltage, all required motor conditions (speed, slip, torque and even heat loss) can be established.

If a disturbance occurs, such as tow rupture during drawing, this disturbance is also registered by a speed sensor and/or by means of the frequency converter, a fault signal is generated and the line can immediately be switched off automatically. For this purpose, the speed and/or the torque of each motor is registered and compared to a given value which can exclusively occur in the event of fault (sudden speed increase). These values are established and saved. By specific adjustment of speeds the respective motors can be designed in an optimum manner, the motor rating can be fully used and costs can consequently be reduced. Moreover, the range of applications of such a line will expand and frequent malfunctions will be avoided.

It is also an advantage that the frequency converter assigned to a motor compares the actual torque with the setpoint torque and then adapts the drive speed of the appertaining motor.

It is beneficial that the surfaces of the godets are chromium-plated or provided with ceramic coating in order to generate higher adhesion.

In an embodiment, the first godet can be driven at a fixed speed which is not changed by the open-loop or closed-loop control system; the speed of the last godet is also fixed, thus determining the drawing ratio. The line is started according to the dotted line (FIG. 7) with a freely selectable starting draw ratio, while the speed increase is distributed among the individual godets either in a linear or freely selectable manner. The tow can be placed on the godets and speed optimization is started. The drives of the individual godets are constantly monitored by means of frequency converters and the actual torque is compared with the calculated average setpoint torque, the speed is thus controlled accordingly while the line is accelerated to maximum speed. Also, the speeds can be saved in a setpoint curve and can be used during the next starting procedure to quicken the starting cycle.

It is also an advantage that optimum drive adjustment of all motors or setting of the desired driving torque for each motor is done automatically through gradual approximation or iteration toward a setpoint torque curve or setpoint torque characteristic.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a drawing line with two drawing units;

FIG. 2 is a top view of the drawing line with two drawing units and one joint drive each;

FIG. 3 is a schematic representation as a top view of an individual motor arrangement for individually and separately driving the godets of a drawing unit;

FIG. 4 is a process speed diagram of the godets in a drawing line with two drawing units according to FIG. 2;

FIG. 5 is a torque diagram of the individual godets of the drawing line according to FIG. 2;

FIG. 6 is a torque diagram of the individual godets in a drawing line with two drawing units according to FIG. 2 with a second speed or drawing profile;

FIG. 7 is a diagram with rising speed curve for adapted torques of a godet arrangement in line with FIG. 3; and

FIG. 8 is a torque diagram for the individual godets of an adjusted machine in line with FIG. 3.

### DETAILED DESCRIPTION

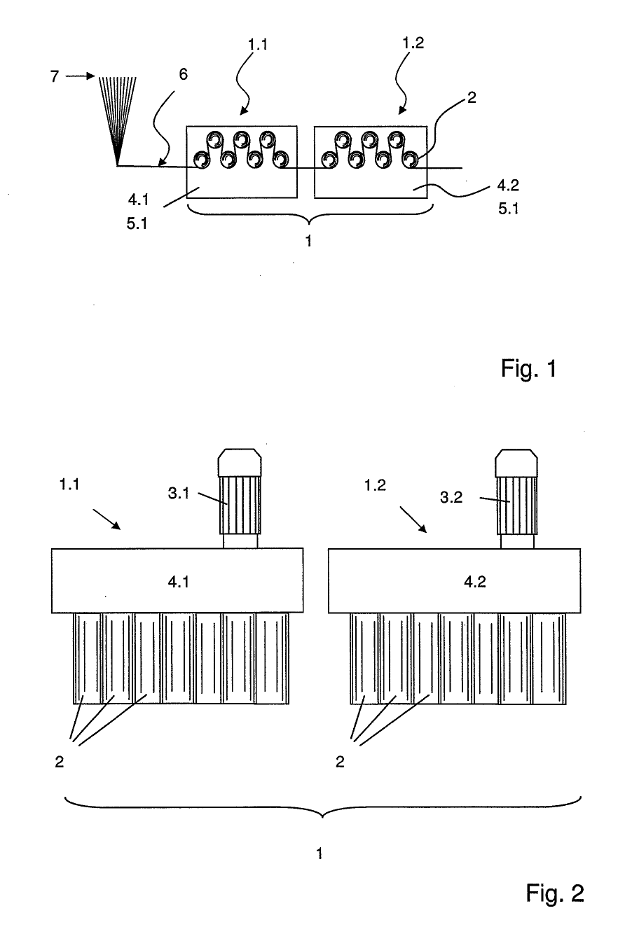

FIG. 1 shows a layout of a drawing line 1 known as such with drawing rollers or godets 2 which are arranged in two drawing units 1.1, 1.2. The two drawing units 1.1 and 1.2 contain arrangements of seven godets 2 each. In a drawing line 1 to the state of the art, as illustrated in FIG. 2, the godets 2 of drawing units 1.1 and 1.2 are driven by a central driving unit or through one assigned motor 3.1, 3.2 each and a gearbox symbolized in the respective frame 4.1, 4.2.

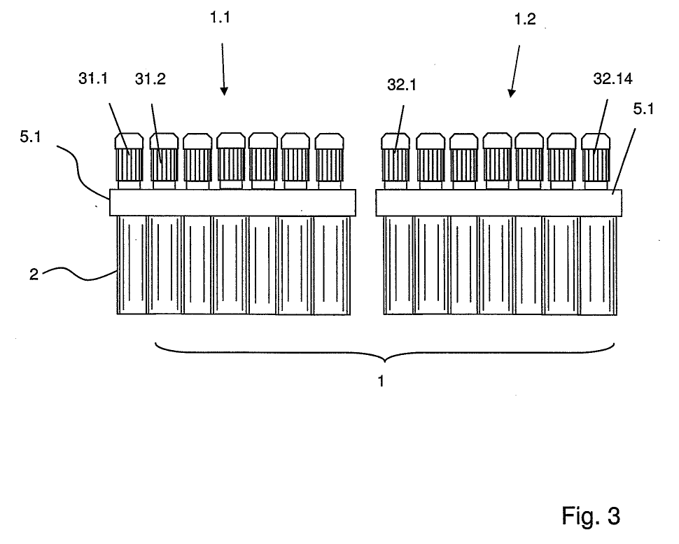

FIG. 3 shows the drawing line 1 according to the invention with a total of fourteen godets 2. The drawing line 1 according to this embodiment includes a first drawing unit 1.1 and a second drawing unit 1.2.

According to FIG. 3, individual motors 31.1, 31.2, . . . 32.14 are mounted in the drawing units 1.1, 1.2 in one support 5.1, 5.2 each, which also contain the bearings for rotation of the godets 2. The supports 5.1, 5.2 are shown only schematically. The sheet with FIG. 3 and the sheet with FIG. 2 both show the overall layout of drawing line 1 as FIG. 1 so that the assignment of drives 31.1, 31.2, . . . 32.14 to the fourteen godets in all of the two drawing units 1.1, 1.2 becomes clear.

Each motor 31.1, 31.2, . . . 32.14, which can be designed as a water-cooled motor, is used for direct drive of an individual godet 2. Inserted between the drive shaft of the motor 3 and the drive shaft of the godet 2 is a joint, a joint shaft or a self-aligning bearing so that lateral offset or effects caused by bending moments can be compensated.

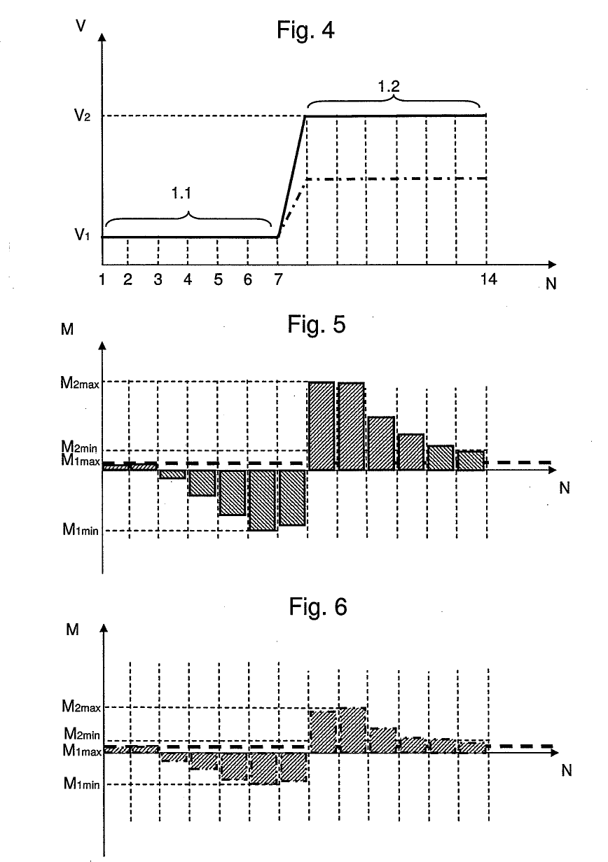

FIG. 4 shows a speed diagram with two different speeds V of a first and second drawing unit 1.1 and 1.2 driven by one motor 3.1 and 3.2 each, where V₁ is the speed (circumferential speed=rotational speed of godet times radius of godet surface; the circumferential speed corresponds to the speed of the tow 6; this description always talks of speed while the value of rotational godet speed results from the above relationship) of the godets 2 of the first drawing unit 1.1 and V₂ is the speed of the godets 2 of the second drawing unit 1.2 (see also FIG. 1 and FIG. 2). The continuous line shows a higher drawing ratio, the dashed line a lower one. The course of the torques M exerted on the godets 2 by the tow 6 (starting from an average torque) is illustrated in the diagrams of FIGS. 5 and 6. The bars shown in continuous outlines in FIG. 5 correspond to a higher drawing ratio and the bars shown in dashed outlines in FIG. 6 to a lower one—see also the speeds represented as continuous and dashed lines in FIG. 4.

FIG. 4 makes it clear that the first drawing unit 1.1 is driven more slowly than the second drawing unit 1.2 so that the tows 6 schematically illustrated in FIG. 1 are drawn. As a result, the total torque taken up by the second drawing unit 1.2 is higher than the torque taken up by the first drawing unit 1.1. The difference in torques between the first and second drawing units 1.1 and 1.2 represents the frictional heat or drawing force, respectively, which is required for drawing the tow or filaments 6. Drawing the molecules of a filament requires a certain drawing force. By drawing the molecule of a filament a certain friction is generated between the individual molecules so that the filaments or the tow can heat up to about 100° C.

FIG. 5 shows the distribution of torques M among the altogether fourteen godets 2 in the two drawing units 1.1, 1.2 (see FIG. 4—continuous line). FIG. 6 shows the distribution of torques for a smaller drawing ratio (FIG. 4—dashed line). The maximum and minimum torques are identified by M₁ₘₓ, M₂ₘₐₓ, M₂ₘᵢₙ etc.

As suggested in FIG. 1, the last drive roller of the last godet 2 in the first drawing unit 1.1 and the first drive roller of the first godet 2 in the second drawing unit 1.2 are wrapped by the tow 6 only by 90° so that at these points not the full torque is transferred. As a result a higher slip occurs at these points. Since the tow 6 can slide over the surface of the godet 2 at these points, the godet is more strongly worn at and does not transfer the full torque either. The drawing forces on the last godet 2 of the first drawing unit 1.1 and on the first godet 2 of the second drawing unit 1.2 mostly are therefore somewhat lower than those on the neighboring godets 2. It is an advantage here that the surfaces of these godets are chromium-plated or have a ceramic coating in order to produce better adhesion.

When calculating the driving force based on the example of FIGS. 1 and 2 (state of the art), the selection of a drive motor is determined by the maximum torque M₂ₘₐₓ (FIG. 5 or FIG. 6), i.e. the driving unit is oversized. Consequently, larger gears are required so that modifications of customary lines according to FIG. 1 are costly and time-consuming.

With a driving unit according to FIG. 3, the energy consumption can be reduced. Here the drives are laid out individually for the maximum demand of the respective godets 2 by grading the specific drive speeds and thus make available for each individual godet 2 a specific ideal driving torque. A total torque M_{d}=M/N must be made available for this purpose, M_{d} being the average torque, M the motor torque and N the number of drive for driving a single godet 2.

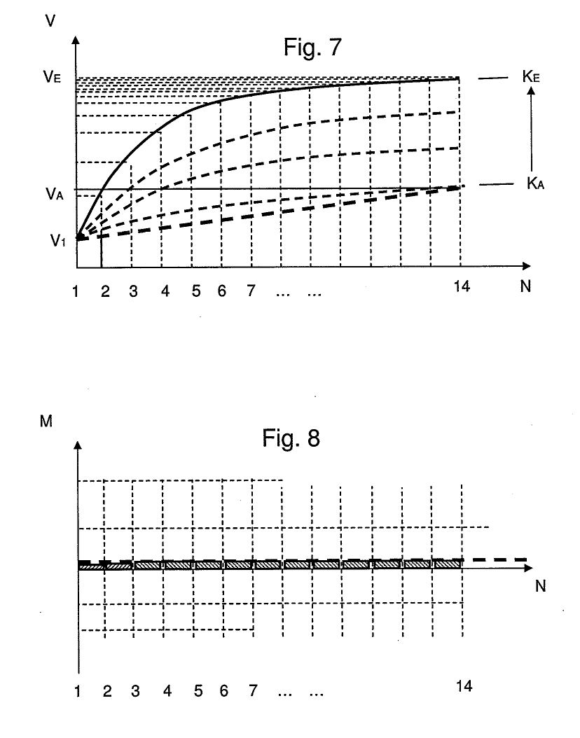

The individual motors 31.1.-32.14 are designed for the specific maximum torque of a godet 2. With the use of a frequency converter, the required speeds V₁ and V₂ can be monitored and adjusted in such a way that the desired drawing effect is achieved for the tow 6. For this purpose, a torque control system is used for driving all motors 31.1-32.14. The previously established M_{d} is the setpoint torque for driving all motors. See also FIGS. 7 and 8.

V₁ is the initial speed which is gradually increased according to the desired drawing effect on the tow 6 to the subsequent values according to FIG. 7 so that the desired drawing effect is achieved. If the actual torque differs from the setpoint torque, the current speed is adapted to the setpoint speed by iteration using the control system.

As shown by FIG. 7, the tow 6 can be easily drawn at the beginning as it still can be strongly elongated. The more the tow 6 has been elongated, the higher the required torque for driving the respective motor 3, as the drawing forces increase with increasing elongation. The speed increments for godets one to seven are much higher than the speed increments of the subsequent godets.

The torques of the godets 2 are sampled several times per time unit so that the drive speed of the individual godets 2 can be adapted. The signal sampled by the control system represents the controlled variable used to determine the required drive speed and thus to determine the required torque of the godets 2.

By continually monitoring the torque and adjusting the required torque, the drive system after a short run-in time is continuously optimized for the required conditions. As a consequence, only the amount of drive energy required for driving each individual motor 3 is made available. Oversizing of the drive unit can be avoided by the control system in line with the invention using the control curve according to FIG. 7.

The drive of a drawing line during the optimization stage is effected by the following process steps:

a) The first godet 2 (FIGS. 7-N=1) is driven at a pre-determined speed V₁ (which is not changed by the control system, thus remains constant and is selected to match the speed, for example, at which the tow 6 arriving from the spinning plant is supplied). Another given speed is the operating speed V₂ of the last godet (according to FIG. 3—driven by motor 32.14). This determines the drawing ratio. This ratio also depends on how the drawn tow 6 shall be further processed.

b) The line is started according to the dashed line (FIG. 7) with a freely selectable starting draw ratio with the speed increase being distributed either in a linear manner (or freely selectable) among the individual godets. This means that the godets (FIGS. 7—N=2, 3, 4 . . . ) following the first godet (FIG. 7—left end, N=1) are driven at a speed increased in a linear manner (or by a freely selectable function). This means that the initial speed distribution is determined, which is identified by K_{A} in FIG. 7. The speed of the last godet (FIGS. 7—N=14) is preferably smaller than the intended final speed V₂. In FIG. 7, V_{A} is the speed of the initial drawing stage, so that in this case V_{A}<V_{E}.

c) The tow 6 is placed on the godets and the torque optimization process is started.

d) The drives 31.1, 31.2 . . . 32.14 of the individual godets 2 are continually monitored by means of the control system and the actual torques compared to the specified setpoint torques. The speeds of the individual godets are controlled accordingly. Based on an initial speed distribution (FIG. 7—curve K_{A}), the drives 31.2 . . . 32.14 of the godets are accelerated—resulting during the individual iterations in the speed distributions suggested by the dashed lines above the starting curve K_{A} in FIG. 7. This optimization process continues until the torques of the individual drives 31.1, 31.2 . . . 32.14 meet the specified setpoints and the torque of the last godet (FIG. 7—N=14) reaches the specified final speed V₂ which defines the draw ratio. The torques of the individual drives 31.1, 31.2 . . . 32.14 are preferably controlled until the situation represented in FIG. 8 is given, namely that the same torque is given throughout.

e) The speeds of the godets of the final curve K_{E} thus obtained are saved and can be used as setpoint values during the next starting procedure to accelerate the start-up process.

As mentioned above, it is possible to drive the last godet (N=14) right from the beginning at the speed V₂ (required speed) defining the draw ratio (V_{A}=V_{E}). Preferably, however, the starting torque is selected according to the formula V_{A} <V_{E} so that unfavorable situations during the optimization stage can absolutely be avoided.

Speed changes (V₁ and/or V₂) during operation of the drawing line in conformity with the invention are carried out analogously. Here also the speeds of the individual godets are optimized in such a way that the specified setpoint torques are reached.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a drawing line or drawing unit for drawing of tows having polymer filaments, the method comprising:
providing a plurality of driven drawing rollers for drawing the tows; and
controlling each drawing roller individually to run at a specified motion value.

2. The method according to claim 1, wherein each drawing roller is controlled to run at a specified rotational speed.

3. The method according to claim 1, wherein a torque exerted by driving motors onto the drawing rollers is influenced.

4. The method according to claim 1, wherein a speed is controlled based on a current control.

5. The method according to claim 1, wherein an actual torque of a motor is registered and compared to a given setpoint and wherein the motor is controlled accordingly.

6. The method according to claim 1, wherein a speed and/or a torque of each motor is registered and compared to given values and wherein exceeding of these values is considered a fault event.

7. The method according to claim 6, wherein the motors are shut down in the event of fault.

8. The method according to claim 1, further comprising:
driving a first godet at a previously determined speed;
determining a speed of the last godet and thereby a draw ratio;
starting the line at a free selectable starting draw ratio with the speed increase being distributed in an either linear or freely selectable manner among the individual godets;
placing the tow on the godets and initiating a torque optimization process;
monitoring continuously the drives of the individual godets and comparing actual torques with calculated average setpoint torques, wherein the speed is controlled accordingly while the line is accelerated to a final speed; and/or
registering the speeds recorded in a setpoint curve and using the registered speeds for a subsequent starting process for acceleration of the start-up procedure.

9. The method according to claim 1, wherein optimum drive setting of all motors or setting of the desired drive torques of the motors is achieved by gradual approximation or iteration toward a setpoint torque curve.

10. A device for driving a drawing line or drawing unit for drawing of tows having polymer filaments via a plurality of driven drawing rollers, to carry out the method according to claim 1, wherein each drawing roller is assigned a separately controllable drive unit.

11. The device according to claim 8, wherein each drawing roller is assigned a speed sensor.

12. The device according to claim 8, wherein the separately controllable drive unit is an asynchronous motor having an assigned frequency inverter.
